(19) United States
(12) Patent Application Publication
(10) Pub. No.: US 2002/0196229 A1
(43) Pub. Date: Dec. 26, 2002

(54) Graphics-based calculator capable of directly editing data points on graph

(76) Inventors: Frank Chen, Taipei Hsien (TW); Chun Hung Chang, Taipei Hsien (TW)

Correspondence Address: BACON & THOMAS, PLLC, 625 SLATERS LANE, FOURTH FLOOR, ALEXANDRIA, VA, 22314

(21) Appl. No.: 09/888,399

(22) Filed: Jun. 26, 2001

(51) Int. Cl. G09G 5/08

(52) U.S. Cl. 345/157

(57) ABSTRACT

A graphics-based calculator has a graph/text converter for converting a data point list into graphic data, a graph display buffer for buffering the graph data so as to display a corresponding graph on an output unit, and a graph generator for generating a cursor on the output unit having a graph shown thereon. The cursor can be moved by the user through the input unit, and when the cursor is moving, the graph generator continuously traces a position of the cursor, so as to selectively modify, delete, and insert a data point in the data point list corresponding to the graph based on the position of the cursor.

### BACKGROUND OF THE INVENTION

1. Field of the Invention

The present invention relates to a calculator and, more particularly, to a graphics-based calculator capable of directly editing data points on graph.

2. Description of Related Art

Calculators have been widely used in a variety of fields in our daily life due to their powerful functions. For example, calculators are applied in shopping, accounting, mathematics, engineering, and statistics for providing simple functions such as arithmetic calculations or complicated functions such as scientific operations and statistic graph outputs. As to a typical graphics-based calculator in making a statistic graph, it is first required to edit input data points in a list. Then a statistic graph can be shown on a screen of the calculator in response to the edited data points. However, the user can not directly delete, insert, or modify the data points on statistic graph if such a graph is unsatisfactory. Typically, the user has to edit the whole list again for making a new statistic graph. This is quite time-consuming and inconvenient in operation, particularly, to the user who intends to view the new statistic graph only. Therefore, it is desirable for the above conventional graphics-based calculator to be improved so as to mitigate and/or obviate the aforementioned problems.

### SUMMARY OF THE INVENTION

The object of the present invention is to provide a graphics-based calculator capable of directly editing data points on graph whereby the user can directly delete, insert, or modify the data point on statistic graph if desired.

To achieve the object, the graphics-based calculator of the present invention comprises: an input unit adapted for a user to operate the calculator; an output unit for showing status and operating results of the calculator; a text editor for editing a data point list input from the input unit; a text display buffer for buffering data input by the text editor so as to display the data on the output unit; a graph/text converter for converting the input data point list into graph data; a graph display buffer for buffering the graph data so as to display a corresponding graph on the output unit; and, a graph generator for providing a cursor shown on the output unit having a graph shown thereon, such that the cursor can be moved by the user through the input unit, and when the cursor is moving, the graph generator continuously traces a position of the cursor, so as to selectively modify, delete, and insert a data point in the data point list corresponding to the graph based on the position of the cursor.

Other objects, advantages, and novel features of the invention will become more apparent from the detailed description when taken in conjunction with the accompanying drawings.

### BRIEF DESCRIPTION OF THE DRAWINGS

FIG. 1 is a block diagram of a graphics-based calculator capable of directly editing data points on graph in accordance with the present invention;

FIG. 2 is a control flow chart of a graphics-based calculator capable of directly editing data points on graph in accordance with the present invention; and

FIGS. 3A to 3C give an example illustrating the process for editing a graph in accordance with the graphics-based calculator capable of directly editing data points on graph in accordance with the present invention.

### DETAILED DESCRIPTION OF THE PREFERRED EMBODIMENT

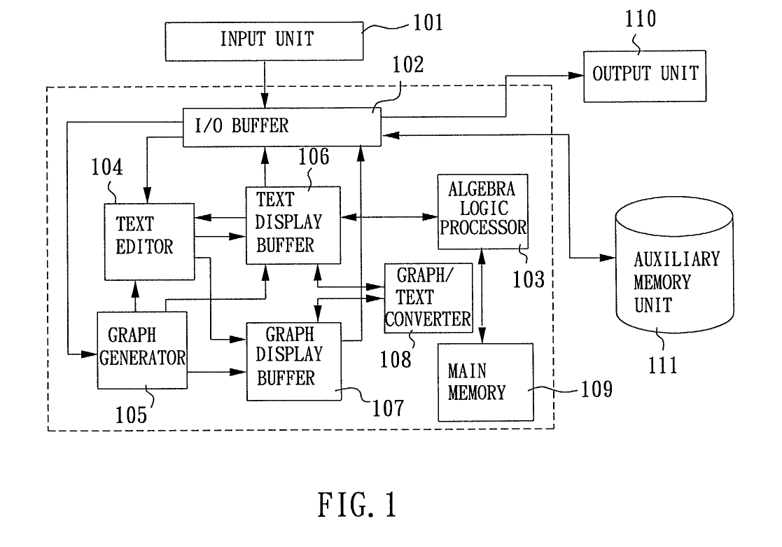

With reference to FIG. 1, there is shown a graphics-based calculator capable of directly editing data points on graph in accordance with the invention. The calculator comprises an input unit 101, an input/output (I/O) buffer 102, an algebra logic processor 103, a text editor 104, a graph generator 105, a text display buffer 106, a graph display buffer 107, a graph/text converter 108, a main memory 109, an output unit 110, and a auxiliary memory unit 111. The components 102-109 can be integrated in a processor on the calculator for providing the functions of logic operation and control.

The input unit 101 aforementioned can be, for example, a keypad or a touch screen panel provided for a user to operate the calculator. The output unit 110 can be a LCD device for displaying the processing status and processing results of the calculator. The auxiliary memory unit 111 can be a data access memory device, which is used together with the main memory 109 to provide the programming codes and memory spaces required for operating the calculator. The algebra logic processor 103 serves to perform functional operations, such as sine function.

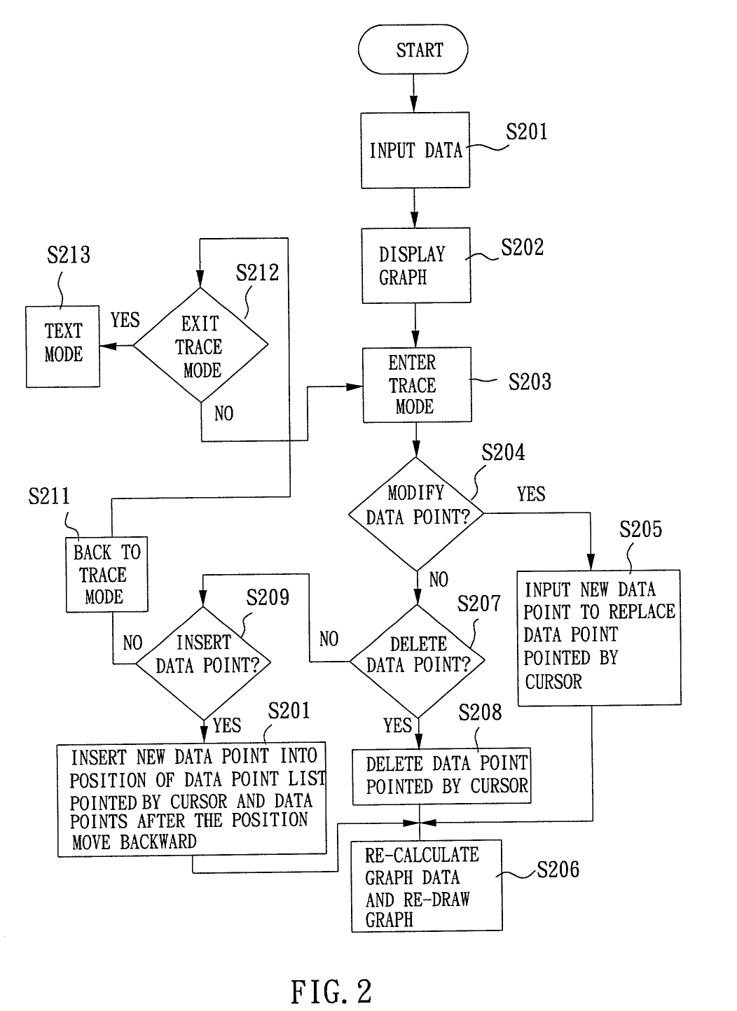

FIG. 2 is a flow chart illustrating a process for editing a graph in accordance with the present invention. In step S201, the data points entered by a user through the input unit 101 or produced by an operation are input to the I/O buffer 102. Such a data point list can be edited by the text editor 104, and then is shown on the output unit 110 through the buffering of the text display buffer 106.

After completing the input of data points, these data points are converted by the graph/text converter 108 into graph data. The graph data is buffered by the graph display buffer 107 so as to display the corresponding graph on the output unit 110 (step S202). At this time, the graph generator 105 provides a cursor shown on the output unit 110. The user may move the cursor by manipulating the input unit 101.

After a graph corresponding to the input data points has been drawn, the user may manipulate the input unit 101 for moving cursor to edit the graph. The graph generator 105 enters a trace mode to continuously trace the current position of the cursor (step S203). For editing the graph, the user may select a function of deleting, inserting, or modifying a data point by manipulating the input unit 101. In step S204, it is determined whether the function of modifying a data point is selected. If yes, process goes to step S205 to input a modified data point to replace the data point pointed by the cursor. In step S206, the graph/text converter 108 determines the graph data of the updated data point list and redraws a new graph.

If the determination in step S204 is no, process then goes to step S207 to further determine whether the function of deleting a data point is selected. If yes, process goes to step S208 to delete the data point pointed by the cursor from the existing data point list. Then, the graph/text converter 108 determines the graph data of the updated data point list and redraws a new graph (step S206).

If the determination in step S207 is no, process then goes to step S209 to further determine whether the function of inserting a new data point is selected. If yes, process goes to step S210 to insert a new data point into a position of the data point list pointed by the cursor and the data points after the position are moved backward, wherein the new data point is entered directly by the user or obtained from performing an operation. Then, the graph/text converter 108 determines the graph data of the updated data point list and redraws a new graph (step S206).

If the determination in step S209 is no, process then goes to step S211 to return to the trace mode. Then, process goes to step S212 to determine whether it is necessary to exit the trace mode. If not, process returns to step S203 to enter the trace mode for executing the graph editing process. If yes, process goes to step S213 to enter a text mode thereby exiting the graph editing process.

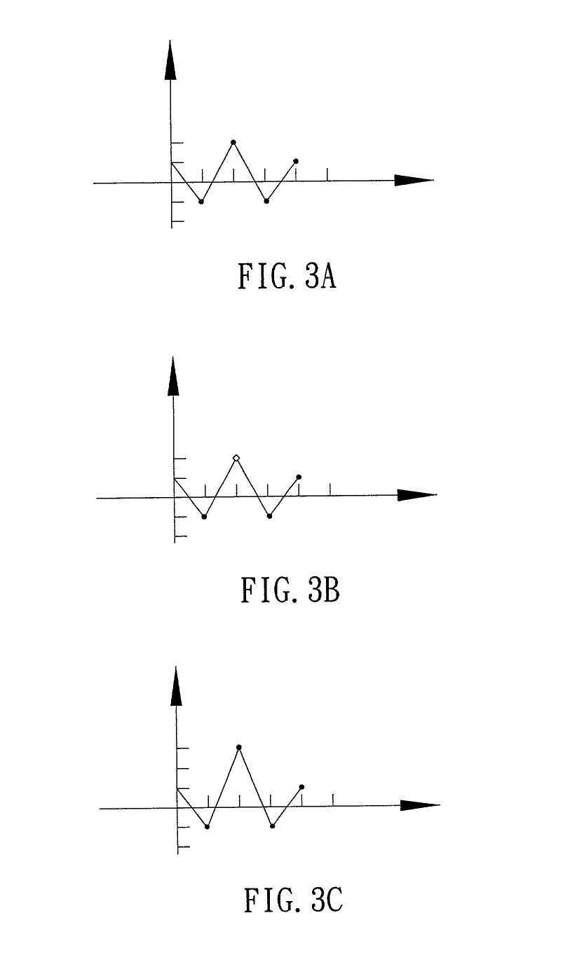

FIGS. 3A to 3C give an example illustrating the process for editing a graph in accordance with the present invention. In FIG. 3A, there is shown a graph that is drawn based on a list having data points of (0,1), (1,−1), (2,2), (3,−3), and (4, 1). FIG. 3B shows that the user moves the cursor to the position of the data point (2,2) for directly modifying this data point to (2,3). Consequently, a resultant graph can be immediately drawn based on the updated list having data points (0,1), (1,−1), (2,3), (3,−1), and (4, 1), as shown in FIG. 3C.

In view of the foregoing, it is known that the graphics-based calculator of the present invention is able to insert, delete, or modify a data point directly on a graph and thus, the user does not need to reenter and reedit the whole list in a text mode for simply viewing a new statistical graph. Accordingly, the graphics-based calculator in accordance with the present invention is convenient in operation and is capable of saving time.

Although the present invention has been explained in relation to its preferred embodiment, it is to be understood that many other possible modifications and variations can be made without departing from the spirit and scope of the invention as hereinafter claimed.

What is claimed is:

1. A graphics-based calculator capable of directly editing data points on graph, comprising:
an input unit adapted for a user to operate the calculator;
an output unit for showing status and operating results of the calculator;
a text editor for editing a data point list input from the input unit;
a text display buffer for buffering data input by the text editor so as to display the data on the output unit;
a graph/text converter for converting the input data point list into graph data;
a graph display buffer for buffering the graph data so as to display a corresponding graph on the output unit; and
a graph generator for providing a cursor shown on the output unit having a graph shown thereon, such that the cursor can be moved by the user through the input unit, and when the cursor is moving, the graph generator continuously traces a position of the cursor, so as to selectively modify, delete, and insert a data point in the data point list corresponding to the graph based on the position of the cursor.

2. The graphics-based calculator as claimed in claim 1, wherein the input unit is operative to modify, delete, or insert a data point in the data point list.

3. The graphics-based calculator as claimed in claim 2, wherein the input unit is operative to input a modified data point to replace an original data point pointed by the cursor, and the graph/text converter determines the graph data of the updated data point list and redraws a new graph.

4. The graphics-based calculator as claimed in claim 2, wherein the input unit is operative to delete a data point pointed by the cursor from the data point list, and the graph/text converter determines the graph data of the updated data point list and redraws a new graph.

5. The graphics-based calculator as claimed in claim 2, wherein the input unit is operative to insert a new data point into a position of the data point list pointed by the cursor and the data points after the position are moved backward, and the graph/text converter determines the graph data of the updated data point list and redraws a new graph.

6. The graphics-based calculator as claimed in claim 5, wherein the new data point is entered directly by a user or obtained from performing an operation.
